(19) United States
(12) Patent Application Publication
(10) Pub. No.: US 2009/0072031 A1
(43) Pub. Date: Mar. 19, 2009

(54) METHOD FOR PAPER-FREE VERIFIABLE ELECTRONIC VOTING

(76) Inventors: Richard J. Cardone, Austin, TX (US); Michael A. Halcrow, Pflugerville, TX (US); Benjamin M. Landman, Cedar Park, TX (US); Kent Yoder, Austin, TX (US)

Correspondence Address: IBM CORPORATION, T.J. WATSON RESEARCH CENTER, P.O. BOX 218, YORKTOWN HEIGHTS, NY, 10598, US

(21) Appl. No.: 11/854,820

(22) Filed: Sep. 13, 2007

(51) Int. Cl. G07C 13/00

(52) U.S. Cl. 235/386; 726/16

(57) ABSTRACT

A method for a paper-free, verifiable, electronic voting system, the method comprising the steps of submitting votes by a voter using a direct-recording electronic voting machine, requesting a ballot summary from the direct-recording electronic voting machine, creating a ballot summary in a verification subsystem, displaying the ballot summary by the voting machine, casting a ballot by the voter, tallying votes by the electronic voting system, requesting the ballot summary be saved by the voting machine, saving the ballot summary securely by the verification subsystem, and displaying a cast ballot message on the voting machine.

### CROSS-REFERENCE TO RELATED APPLICATIONS

Cross reference is made to the following co-pending, commonly assigned, US patent applications which were filed concurrently with this application: U.S. Ser. No. ______ entitled “System for Paper Free Verifiable Electronic Voting” (Atty. Docket Number YOR920070507US1); and U.S. Ser. No. ______ entitled “A System for Electronic Voting Using a Trusted Computing Platform” (Atty. Docket Number YOR920070531US1); and U.S. Ser. No. ______ entitled “A Method for Electronic Voting Using a Trusted Computing Platform” (Atty. Docket Number YOR920070531US2), whose content is incorporated herein by reference in its entirety.

### FIELD OF THE INVENTION

The present invention generally relates to the ability to verify voting using electronic computing devices and, more particularly, relates to a method that allow paper-free verifiable voting, recounts, and audits without relying on printed ballots.

### BACKGROUND

Today's Direct-Recording Electronic (DRE) voting systems are often built using proprietary hardware and software. Systems that use touch screen displays for capturing voter input are examples of DRE systems. To meet legal requirements for use in public elections, voting system verification is typically performed by testing labs licensed by government and contracted by manufacturers under non-disclosure agreements. The voting systems usually incorporate commercially available operating systems and other off-the-shelf software that, by law, is outside the verification testing performed by the licensed labs.

This approach of using proprietary voting system hardware and software that are not available for public scrutiny, in conjunction with tens of millions of lines of unverified operating system code, has led to well-documented security exposures and to incidents in which voting systems have failed during public elections. So far, no reported failures of voting systems in U.S. public elections were do to malicious intent, such as a software virus or sabotage by an election worker, but the use of standard, commercial operating systems in an unverified environment does expose voting systems to those risks.

DRE systems, if compromised, present a particularly troubling risk for public elections, since the system itself controls all vote recordkeeping. Typically, DRE systems do not keep copies of individual ballots, but, instead, only keep running totals of voter selections. If a recount needs to be performed, the only records are the tallies already calculated by the system. Unfortunately, those tallies rely on the same devices whose integrity may be in question. Consider a DRE system that has been compromised so that voters see their intended choices on all output presentations, but, in fact, all saved and tallied copies of their votes are altered to favor one candidate or political party. Studies have shown that in a close statewide election, switching a few votes from one candidate to another in every precinct is enough to alter the election's outcome. More to the point, there are numerous, well-documented cases in recent elections in which electronic voting systems have improperly assigned or tallied votes.

To address the risks inherit in current electronic voting systems, especially in DRE systems where there is no raw input record to inspect if a recount is required, several states have passed laws requiring that electronic voting systems print a paper record of each voter's ballot. This hardcopy record may be designated as the legal ballot, or it may be used only as a backup to the electronically tallied votes in case of recounts, but in either case the printed record cannot leave the polling place with the voter. This latter requirement is necessary to avoid vote buying, selling, and coercion schemes.

Even though system generated hardcopies would allow voters to inspect their selections before their votes are cast, a compromised system could still tally votes inaccurately. Any discrepancies, however, between the electronically tallied votes and the hardcopy records should be detectable during recounts and audits, which is why these systems are often called verifiable electronic voting systems.

The problem with such verifiable electronic voting systems is that they rely on electromechanical printers to provide verifiability. Printers are much less reliable and much less durable than the purely electronic components that make up much of the rest of system. Paper jams, problems with ink cartridges or toner (for non-thermal printers), garbled text, and software problems involving print queues occur all too frequently, especially with low-cost printers. Printers often require some type of calibration; they are sensitive to shock, rough handling, humidity, and temperature; and they require a continuous paper supply and attention during operation.

In the context of public elections, adding a printer to every DRE input device represents a substantial initial expense that must be borne by every voting district; a continuing expense of supplies, setup, maintenance and repair; and a records retention expense with regard to the handling of hardcopy output. On Election Day, the management of hardcopy records requires poll workers to follow specific, legally sanctioned procedures. When one considers that most election workers are volunteers or temporary employees, that they have limited training and work long hours on election day, and that just moving around boxes of printer supplies and printer output adds significantly to the physical burden of their jobs, the attractiveness of verifiable electronic voting systems that do not rely on printed records becomes apparent.

### SUMMARY

The following invention addresses the problem of verifiable electronic voting systems and avoids the issues associated with hardcopy voting records. The invention uses trusted computing platforms and procedures for digital ballot handling to assure voters that their ballots are accurately tallied. In addition, the invention provides a secure digital record of raw voter input that is separate from the electronically tallied totals. This raw input can be used for recounts and audits by election officials while preserving voter anonymity.

DRE voting systems capture voter choices using an electronic input device. These input devices typically present ballot information to voters on a graphical display. Voters can make their selections directly through the display if it accepts touch, light pen, or some other type of input. Otherwise, voters use a pointing device or screen navigation control to make their selections.

The main functions performed by such a DRE input device are to present each voter with an appropriate ballot, to allow a voter to enter and review his or her selections, and then to record the selections while preserving anonymity as required by the rules of the election. DRE voting systems can also include zero or more of the following components: one or more vote tallying components; one or more voter validation components; one or more voter registration databases; and wired or wireless connections between some or all of the devices.

Vote tallying entails the accurate counting of all votes on all valid ballots. Voter validation entails checking that each voter is authorized to vote in the election based on the rules that govern the election. A voter registration database stores information about registered voters and their eligibility to vote in elections.

The vote tallying, voter validation, voter input functions are often implemented on separate devices, though this is not a requirement and various functions can be combined on one device. Similarly, the voter registration database can be located on hardware that also houses one or more of the other system functions. For instance, multiple installations of the database can exist across multiple polling places and these installations may or may not contain precisely the same information.

The present invention works by requiring that each electronic computing device that is part of an electronic voting system execute as a trusted computing platform and communicate only with other trusted devices over secure channels. A trusted computing platform can on demand cryptographically verify its state and, therefore, its integrity. Trusted computing platforms typically include a tamper-resistant microprocessor that measures the state of the machine, maintaining a log of all software that has run on the machine since the machine was turned on. This microprocessor can cryptographically sign the log and bind data to this log, so that a third party can have assurance that the machine only ran trusted software from the time it booted up until the time the measurement was taken.

The most prominent example of such a microprocessor is the Trusted Platform Module (TPM), which has been standardized by the Trusted Computing Group™ (https://www.trustedcomputinggroup.org). The TPM forms the basis of a trusted computing platform by protecting against virtual and physical attacks. The TPM is a microprocessor that can be embedded into a device, such as the motherboard of a personal computer or server. This embedded chip securely stores digital keys, certificates, and passwords. The chip also comprises a random number generator and the ability to perform certain cryptographic operations, such as the generation of new keys.

By running on a trusted computing platform, each device in an electronic voting system operates in a verified environment such that, at any point in time, only known and uncorrupted software is loaded into memory and executed. Moreover, each device can attest to its state and communicating devices can perform mutual attestation to verify to each other that both devices are in a valid state before communicating. Using this secure foundation, a trusted electronic voting system can accurately capture, count, and report the votes cast in an election.

One novelty of the present invention is the use of a trusted computing platform to provide a verifiable, digital record of all cast ballots. This verification record augments the running tallies that DRE systems currently maintain. The main use of the verification record is to provide the raw data for election recounts and audits. Voters and election officials can have confidence in their voting system because of the guarantees that a well-designed trusted computing platform makes, including the ability to check election results using securely saved ballot information.

The basic scenario for creating and using verifiable digital ballots starts with a voter selecting his electoral preferences using a DRE input device. When the voter indicates that he would like to cast his ballot, a displayable ballot summary is created by ballot verification subsystem of the voting system. A ballot summary is a file that comprises all of the selections that a voter has made and is presented to the voter on a display device. The voter inspects the ballot summary to see if his intended selections have been recorded. When the inspection is complete, the voter can choose to either cast his ballot as is or continue making selections.

Ballots can only be cast when the ballot summary is being displayed. The act of casting a ballot executes two processes. One process is the DRE system tally process that current DRE systems perform. The other process is carried out by the ballot verification subsystem and its main task is to securely save the ballot summary that the voter reviewed. This ballot summary is saved so that it is cryptographically tamper-resistant, protective of voter anonymity, accessible only to authorized users, and preserved in the exact format that was presented to the voter before the ballot was cast. The ballot verification subsystem is responsible for securely maintaining the stored ballot summaries, for outputting them when required, and for deleting them when they are no longer needed.

Another novel characteristic of the present invention is its use of a trusted computing platform in combination with a secure digital ballot record to create a trustworthy audit trail for elections. The TCP guarantees that the system executes as expected and, in particular, that the ballot summaries reviewed by voters are securely saved without modification. This saved ballot information provides a valid basis for recounts and audits if one trusts the correctness of the ballot verification subsystem. Trust in the ballot verification subsystem is established through various types of design reviews, code inspections, and testing.

In one aspect of the present invention, shown is a method for a paper-free, verifiable, electronic voting system, the method comprising the steps of: submitting votes by a voter using a direct-recording electronic voting machine; requesting a ballot summary from the direct-recording electronic voting machine; creating a ballot summary in a verification subsystem; displaying the ballot summary by the voting machine; casting a ballot by the voter tallying votes by the electronic voting system; requesting the ballot summary be saved by the voting machine saving the ballot summary securely by the verification subsystem; and displaying a cast ballot message on the voting machine.

In yet another aspect of the present invention, the electronic voting system executes as part of a trusted computing platform.

In yet another aspect of the present invention, the trusted computing platform allows only known, verified code to execute as part of the electronic voting system.

In yet another aspect of the present invention, all components of the trusted computing platform and of the electronic voting system have been independently certified as secure and correct in accordance with applicable laws.

In yet another aspect of the present invention, shown is a method for a paper-free, verifiable, electronic voting system, further comprising the steps of: performing a mutual attestation protocol between a verification client and a verification server, possibly over a network, the verification client and the verification server being parts of the verification subsystem.

In yet another aspect of the present invention, shown is a method for a paper-free, verifiable, electronic voting system, further comprising the steps receiving at a verification server a request over the network from a verification client to save a ballot summary; sending a response from the verification server to the verification client after saving the ballot summary securely by the verification subsystem; receiving the response by the verification client; and displaying a cast ballot message on the voting machine.

In yet another aspect of the present invention, shown is a method for a paper-free, verifiable, electronic voting system, the method further comprising the steps of: signing on to an administrator console by an administrator; authenticating and authorizing the administrator on a verification subsystem; requesting deletion of the ballot summary by the administrator; archiving the ballot summaries by the verification subsystem; saving the ballot summaries by an output device; and deleting the ballot summaries by the verification subsystem.

In yet another aspect of the present invention, shown is a method for a paper-free, verifiable, electronic voting system, the method further comprising the steps of: signing on to an administrator console by an administrator; authenticating and authorizing the administrator on a verification subsystem; requesting a ballot summary output by the administrator; decrypting and checking the integrity of requested the ballot summaries; and outputting verified ballot summaries in clear text.

In yet another aspect of the present invention, shown is a method for a paper-free, verifiable, electronic voting system further comprising the step of digitally signing each individual ballot summary to cryptographically assure authenticity and integrity.

In yet another aspect of the present invention, shown is a method for a paper-free, verifiable, electronic voting system, further comprising the step of encrypting each individual ballot summary to cryptographically assure authenticity, integrity, and confidentiality.

In yet another aspect of the present invention, shown is a method for a paper-free, verifiable, electronic voting system, further comprising the step of digitally signing multiple ballot summaries to cryptographically assure the authenticity and integrity of the ballot summaries as a unit.

In yet another aspect of the present invention, shown is a method for a paper-free, verifiable, electronic voting system, further comprising the step of encrypting multiple ballot summaries to cryptographically assure authenticity, integrity, and confidentiality of the ballot summaries as a unit.

In yet another aspect of the present invention, shown is a method for a paper-free, verifiable, electronic voting system, further comprising the step of sealing the ballot summaries such that they cannot be read unless the trusted computing platform is in an expected configuration.

In yet another aspect of the present invention, shown is a method for a paper-free, verifiable, electronic voting system, further comprising the step of writing the ballot summaries to a fully encrypted storage device.

In yet another aspect of the present invention, shown is a method for a paper-free, verifiable, electronic voting system, further comprising the step of making source code of the electronic voting system publicly available to increase confidence in correctness of the electronic voting system.

In yet another aspect of the present invention, shown is a method for a paper-free, verifiable, electronic voting system, further comprising the step of allowing a trusted third party to inspect, validate, attest to, and keep in escrow source code of the electronic voting system to increase confidence in correctness of the electronic voting system.

In yet another aspect of the present invention, shown is a method for a paper-free, verifiable, electronic voting system, further comprising the step of protecting voter anonymity by obfuscating an order in which the ballot summaries are created and saved.

In yet another aspect of the present invention, shown is a method for a paper-free, verifiable, electronic voting system, further comprising the step of saving the ballot summaries to random locations in the ballot summary repository.

In yet another aspect of the present invention, shown is a method for a paper-free, verifiable, electronic voting system, further comprising the step of removing, disabling, or overwriting timestamps associated with the saved ballot summaries.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a standalone voting machine configuration;

FIG. 2 is a block diagram of a distributed voting system configuration;

FIG. 3 is a flow diagram depicting saving a ballot summary in a standalone configuration;

FIG. 4 is a flow diagram depicting saving a ballot summary in a distributed configuration;

FIG. 5 is a flow diagram depicting outputting ballot summaries;

FIG. 6 is a flow diagram depicting deleting ballot summaries; and

FIG. 7 is a block diagram of a voting system utilizing a Trusted Computing Platform.

### DETAILED DESCRIPTION

The function of a Trusted Computing Platform (TCP) as described herein is to securely and accurately record the software state of a platform and to report that state to other platforms in a verifiable way. In this context, platform usually corresponds to a device.

The Trusted Computing Group (TCG) has delivered a set of standards that have been used to implement all the components necessary to achieve a TCP. The following description of a TCP can be implemented using TCG standardized components or any other methodology that achieves the same ends.

Each TCP comprises a statistically unique asymmetric key pair, either generated at machine manufacture time or after delivery to the customer, which we'll call the platform key. The platform key is used for public key cryptography and comprises a public and private part. The private part of the key pair should not be discoverable by system software, but operations using the key such as encrypt, decrypt, sign and verify, should be allowed. This can be accomplished either by providing a tamper resistant piece of hardware containing the key, or in a virtualized OS environment, a specialized software partition with the necessary functionality.

The platform key represents a root of trust on which all system validation depends. A root of trust uses cryptographic techniques to protect the system from software attacks. Hardware attacks, however, are countered by keeping the system physically secure. Trust is extended from the root to higher layers of system firmware and software by establishing a chain of trust from one layer to the next. This chain of trust starts at the root, which verifies the first layer of system firmware/software. This verified layer then verifies the next layer of firmware/software and the process continues until all components of the trusted computing platform are included.

For example, the root of trust in a personal computer can be a tamper resistant chip, such as a TPM, that comprises the platform key. When the system boots, this TPM chip verifies itself and the first layer of firmware or software, which then verifies the next layer of firmware/software, and so on. In a trusted electronic voting system, the chain of trust would start at the platform key and include, in order, the BIOS, the OS loader, the OS, and the voting application. Except for the root, each link in this chain is verified by its predecessor.

A trusted third party (TTP) can use the system-specific platform keys to help one platform verify that another platform is a TCP. This process involves the TTP issuing a trusted certificate to each trusted platform once those platforms have proven their support for the required trusted computing features. The trusted certificate associates the public part of a platform key with its platform and represents the TTP's confidence that the platform is a TCP.

The TCP platform maintains a comprehensive list of the software that has been executed on the machine, called a software integrity log. This list includes all software executed after the machine is in a known secure state, such as immediately before the BIOS of the machine begins to execute, or, if a trusted hypervisor is used, after the hypervisor has loaded. When requested by a challenger, that is, another machine that wants to verify the trust state of a trusted computing platform, the TCP provides the software integrity log in an agreed upon format. The queried TCP signs the log using its private key and the challenger verifies the signature using information in the trusted certificate.

Specifically, the challenger compares the software integrity log returned by the TCP to a reference integrity log associated with that TCP. The reference log, which can be part of the trusted certificate created by the TTP, represents the expected configuration for a TCP. In voting systems, we call this expected configuration the device's election configuration. A challenger, once armed with a TCP's trusted certificate and reference log, is ready to verify a TCP's identity and configuration. Using the trusted certificate and TCP signature, the challenger verifies the identity of the TCP and the integrity of the software log returned by the TCP. Using the verified software integrity log, the reference integrity log, and other software integrity metrics returned by the TCP, the challenger validates that only expected, trusted programs have been executed on the TCP.

This process of requesting and receiving all the data necessary to determine if a platform is trustworthy is called quoting and allows devices to attest their trustworthiness to each other. In voting systems, a mutual attestation protocol is used so that the trustworthiness of both devices is established before data is exchanged. Once both devices are known to be in a trusted state, a secure connection can be established between them.

An election is administered by an election authority, which in public elections is the governmental agency, such as the County Clerk, entrusted by law to collect votes in a geographic jurisdiction in a prescribed manner. The election authority divides its jurisdiction into precincts and the people that reside in the same precinct vote at the same polling place. Each precinct has one or more poll workers responsible for setting up and running the election in the precinct. We call the head poll worker at each precinct the precinct judge. For simplicity of this example, we assume a one-to-one correspondence between precincts and polling places, though this is not always the case.

A trusted electronic voting system is a voting system that only runs on one or more trusted computing platforms. Specifically, a trusted electronic voting system conforms to the following design principle: During an election, any computing device that is part of the voting system either initializes as a trusted computing platform in its election configuration or does not initialize at all. Each transaction between devices proceeds only after they have mutually attested their identities and election configurations. Any data exchanged between devices during an election have their integrity and, where necessary, their confidentiality cryptographically protected.

The present invention applies to DRE voting systems that are trusted electronic voting systems and that provide a verifiable record. We call these systems Verifiable DRE Voting Systems (VDVS).

Each DRE voting machine can have a persistent storage medium on which the ballots cast from that machine are stored. In this configuration, the complete firmware/software stack used to write to the storage medium is part of the TCP. This allows the integrity of the firmware/software stack to be attested. The ballot verification subsystem securely maintains the ballot summaries until an authenticated user with proper authorization requests to view, copy, print, or delete the ballots.

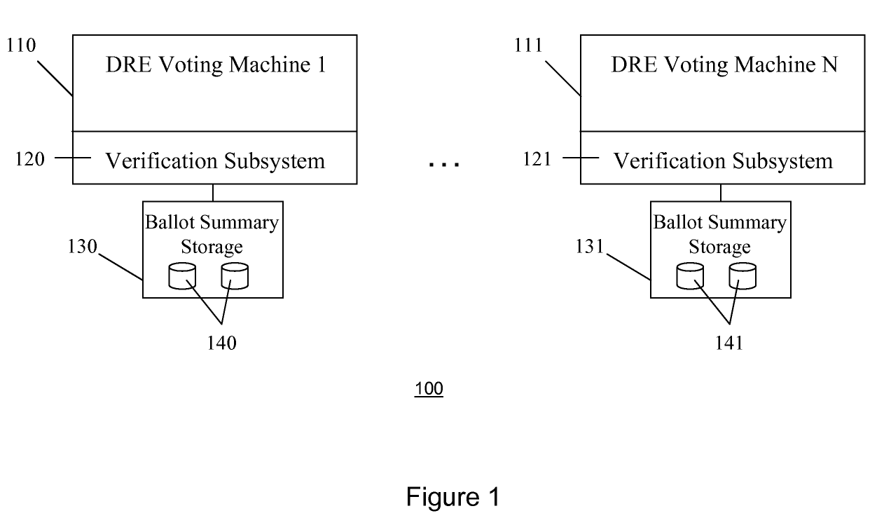

Turning now to the Figures, FIG. 1 shows a Verifiable DRE Voting Systems (VDVS) 100 that consists of one or more DRE voting machines, 110, 111, each of which includes a ballot verification subsystem, 120, 121, respectively. Each verification subsystem controls its own persistent storage, Ballot Summary Storage 130, 131, respectively. These storage systems can use redundant hardware to improve system reliability as illustrated by storage units 140, 141. Typically, the Ballot Summary Storage 130, 131, will reside in the DRE Voting machines 110 and 111. However it can be appreciated that Ballot summary storage can be outside of voting machines 110, 111. In the standalone configuration as shown, individual DRE voting machines 110, 111 continue to be responsible for tallying and securing the votes cast on them. In addition, this invention extends DRE responsibility to include managing individual ballot verification subsystems 120, 121 and storage 140, 141.

Any device that is part of the VDVS 100 can accumulate ballot summaries from one or more DRE's. These devices include, but are not limited to, a designated DRE, a tally server, or any other networked device in the VDVS. In a remote storage configuration, the complete firmware/software stacks that are used to transmit and store the ballots summaries on both the sending and receiving devices are part of the TCP. This allows the integrity of the firmware/software stacks to be attested. Ballot summaries are transmitted to the storing devices using a secure channel that cryptographically guarantees ballot integrity and, where necessary, ballot confidentiality. The ballot verification subsystem securely maintains the ballot summaries until an authenticated user with proper authorization requests to view, copy, print, or delete the ballots.

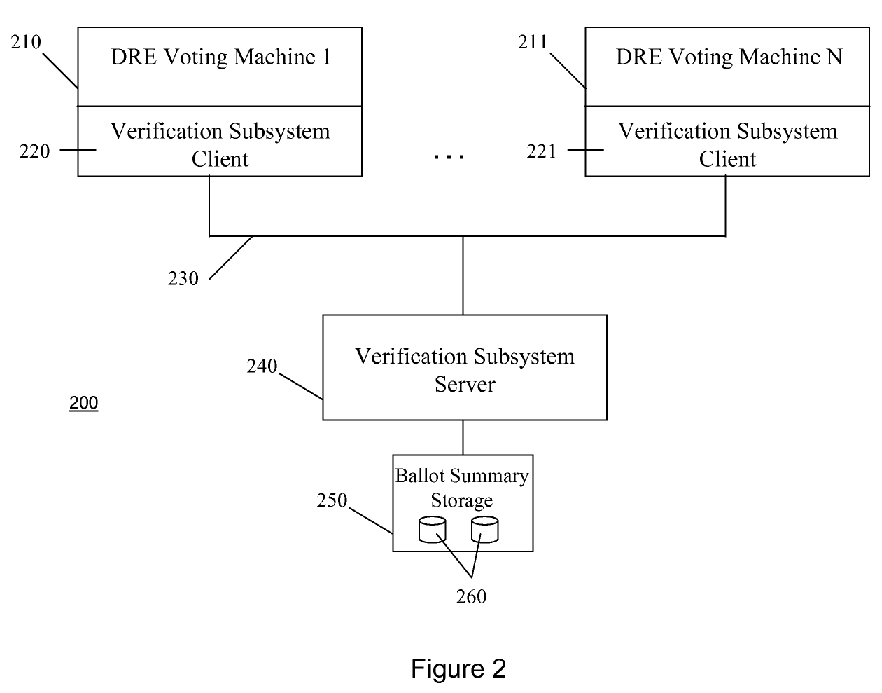

Turning next to FIG. 2, illustrated is another possible distributed VDVS configuration 200. The configuration shown includes one or more DRE voting machines, 210, 211. Each DRE comprises all the typical DRE function required to display ballots and record voter selections, plus the client portion of the ballot verification subsystem client 220, 221 used to initiate verification subsystem requests.

In FIG. 2, DRE voting machines 210, 211 are connected to network 230, which allows verification subsystem clients 220, 221 to communicate with verification subsystem server 240. This server runs as a trusted computing platform and services verification subsystem requests from verification subsystem clients attached to network 230. Though not shown, server 240 can also fill other voting system roles, such as the tally server role, in addition to is verification subsystem role. The verification subsystem server includes ballot summary storage 250, which may contain redundant storage devices 260 for improved reliability. Typically, ballot summary storage 250 resides in the server housing, but as can be appreciated, storage can also be located remotely.

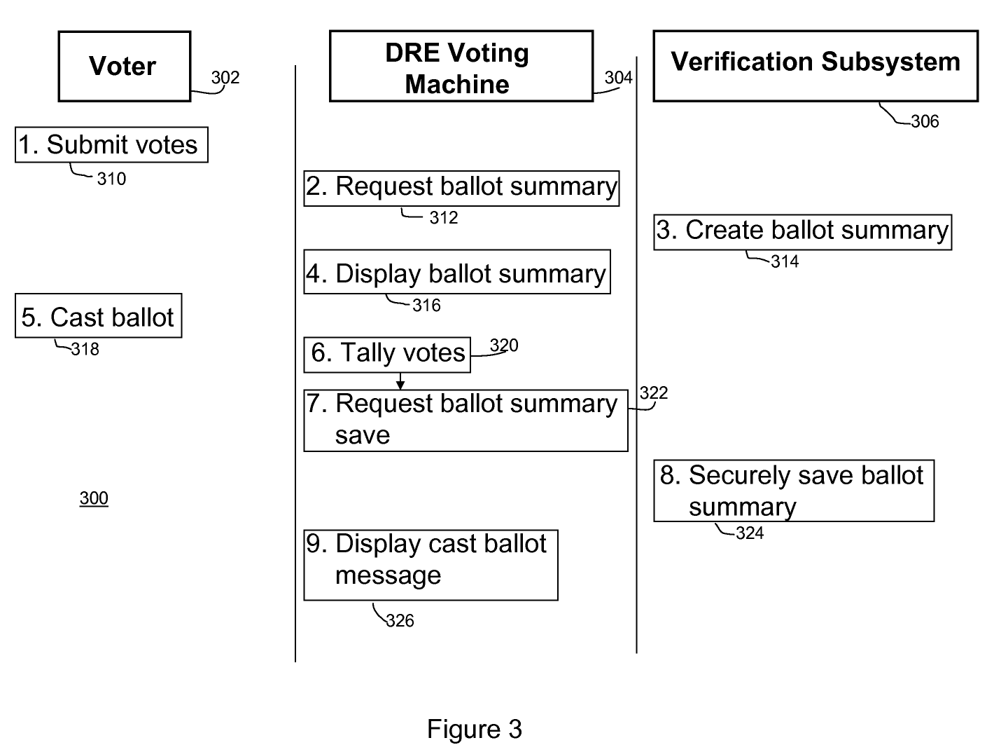

FIG. 3 specifies the protocol used to save a ballot summary in a standalone DRE configuration 300 which comprises a voter 302, voting machine 304 and verification system 306. In step 310, the voter 302 makes his selections and then submits his votes to be counted. In step 312, the DRE voting machine 304 requests that a new ballot summary be created using the voter's current selections. In step 314, the ballot verification subsystem 306 creates the ballot summary and returns it to the DRE voting machine 304 graphics code for display in step 316. After checking the selections, the voter 302 can choose to cast the ballot as is or to update the selections. In FIG. 3, the voter chooses to cast the ballot in step 318. This choice causes the DRE voting machine 304 to tally the voter's selections in step 320. In addition, the DRE voting machine 304 initiates a ballot summary save operation in step 322, which causes the previously created ballot summary to be saved in step 324 by verification system 306. The integrity and, if necessary, the confidentiality of the saved ballot summary is guaranteed using the cryptographic facilities of the TCP. Once the ballot summary is successfully saved, the DRE voting machine 304 indicates to voter 302 that the vote has been cast in step 326.

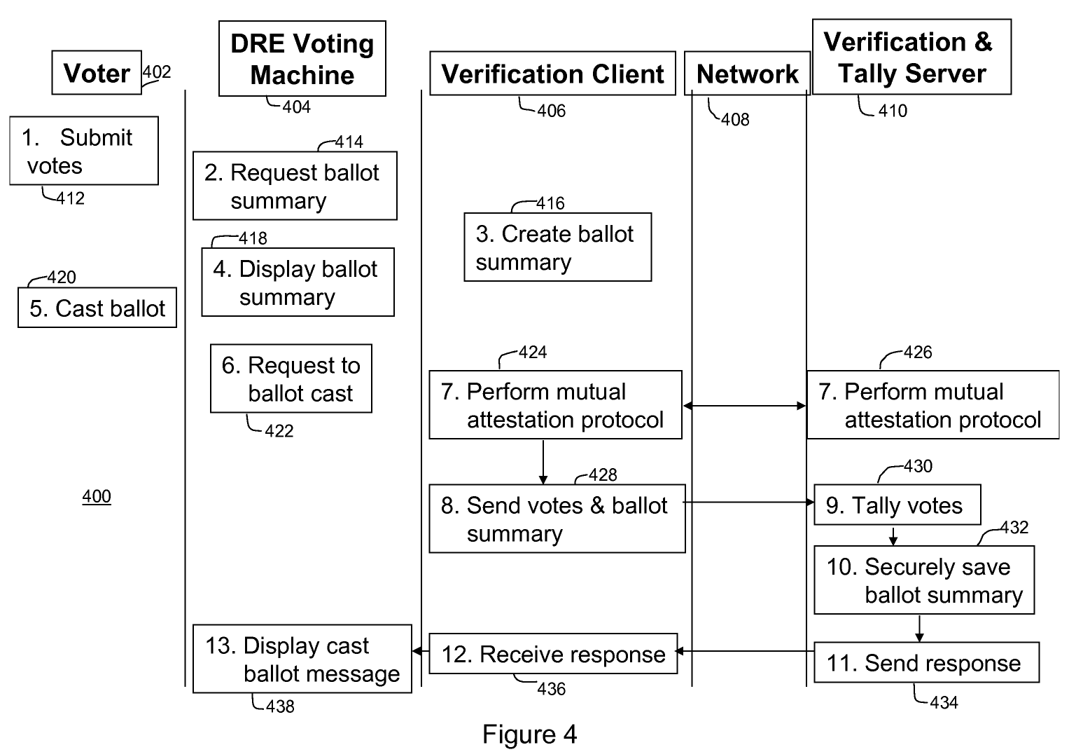

FIG. 4 specifies the protocol to save a ballot summary in a distributed DRE Voting system configuration 400, which is a configuration where the ballot verification subsystem is split into client and server components. Components include voter 402, DRE voting machine 404, verification client 406, network, 408 and verification tally server 410. Note that verification subsystem 306 of FIG. 3 in distributed between the verification client 406 and the verification & tally server 410 of FIG. 4. In step 412, the voter 402 makes a selection and then submits the votes to be counted. In step 414, the DRE requests that a new ballot summary be created using the voter's current selections. In step 416, the ballot verification subsystem creates the ballot summary and returns it to the DRE graphics code for display in step 418. After checking his selections, the voter can choose to cast the ballot as is or to update his selections. In FIG. 4, the voter chooses to cast his ballot in step 420. This choice causes the DRE to request that the ballot be cast in step 422.

Once the request to cast a ballot is made, the verification client 406 initiates the mutual attestation protocol in step 424 and 426 over network 408. This protocol allows both the verification client 406 and verification tally server 410 to each verify that the other has a valid identity and is in its expected election configuration. Once the mutual attestation protocol successfully completes, the verification client 406 sends the voter's selections and the previously created ballot summary to the server in step 428. In step 430, the server 410 tallies the votes as it would in a conventional distributed system. In step 432, the server 410 saves the ballot summary using its verification subsystem component. The integrity and, if necessary, the confidentiality of the saved ballot summary is guaranteed using the cryptographic facilities of the Trusted Computing Platform or TCP. The server 410 then sends a response message in step 434, which the verification client receives in step 436 using network 408. In step 438, the DRE system 400 indicates to the voter 402 that the vote has been successfully cast.

The configuration in FIG. 4 consists of front-end DRE voting machines 404 that manage the interaction with voter 402 and a tally server 410 that performs the tallying and ballot summary saving. As can be envisioned, there are other ways to configure a distributed DRE system 400, but FIG. 4 illustrate the protocol for a combined tally/verification server 410.

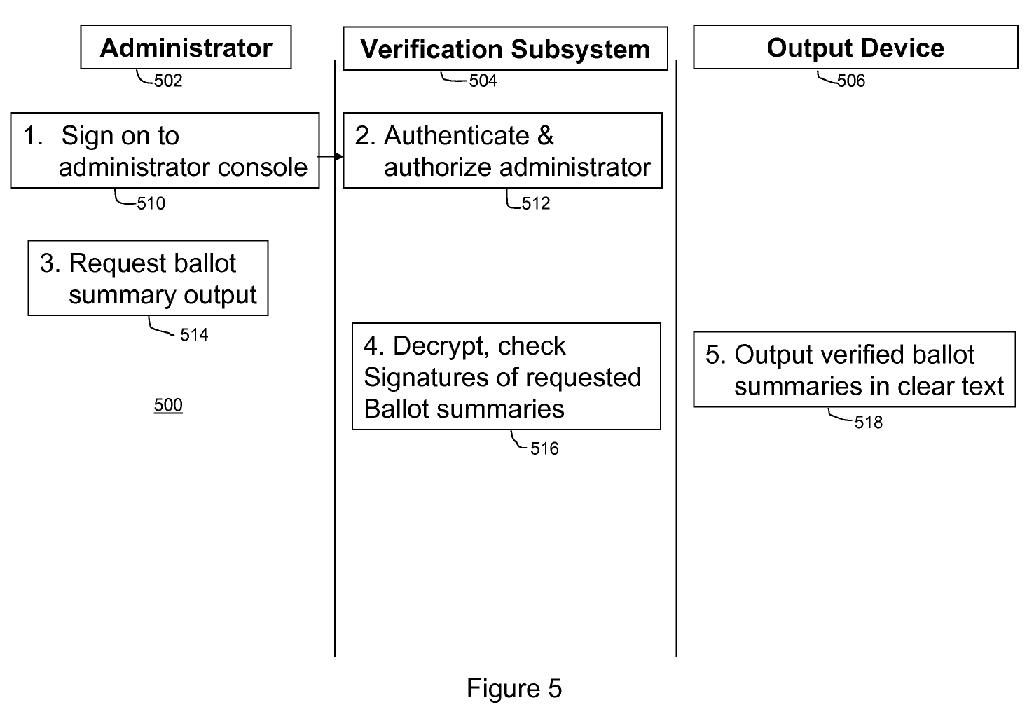

During or after an election, ballot summaries can be outputted for audit or recount purposes. FIG. 5 shows a flow diagram for the basic protocol for generating ballot summary output using ballot summary system 500, which includes administrator 502, verification system 504 and output device 506. In step 510, an administrator 502 attempts to sign on to the administrator console of the verification subsystem 504. This sign on procedure takes place on the device that stores the ballot summaries, which by definition is a TCP that only operates when it is in a known state. In step 512, the administrator's identity is authenticated and permissions are checked to make sure that the administrator is authorized to perform the ballot summary output operation by verification subsystem 504. Authentication can use any available method including, but not limited to, passwords, biometrics, smart cards, or combinations thereof. Once identity has been established, the administrator 502 can only perform operations that have previously been granted. In addition, the sign on procedure for the verification subsystem can be integrated into other VDVS authentication and authorization procedures.

Once authenticated and authorized, the administrator requests in step 514 that ballot summaries be outputted. Depending on the rules that govern the election, the verification subsystem may allow some or all of the ballot summaries to be outputted. In step 516, the requested ballots are cryptographically checked for integrity and, if necessary, decrypted by verification subsystem 504. The clear text ballot summaries are then written to output device 506, which may be a printer, display, hard drive, memory card, or any other device that is part of the TCP as show in step 518.

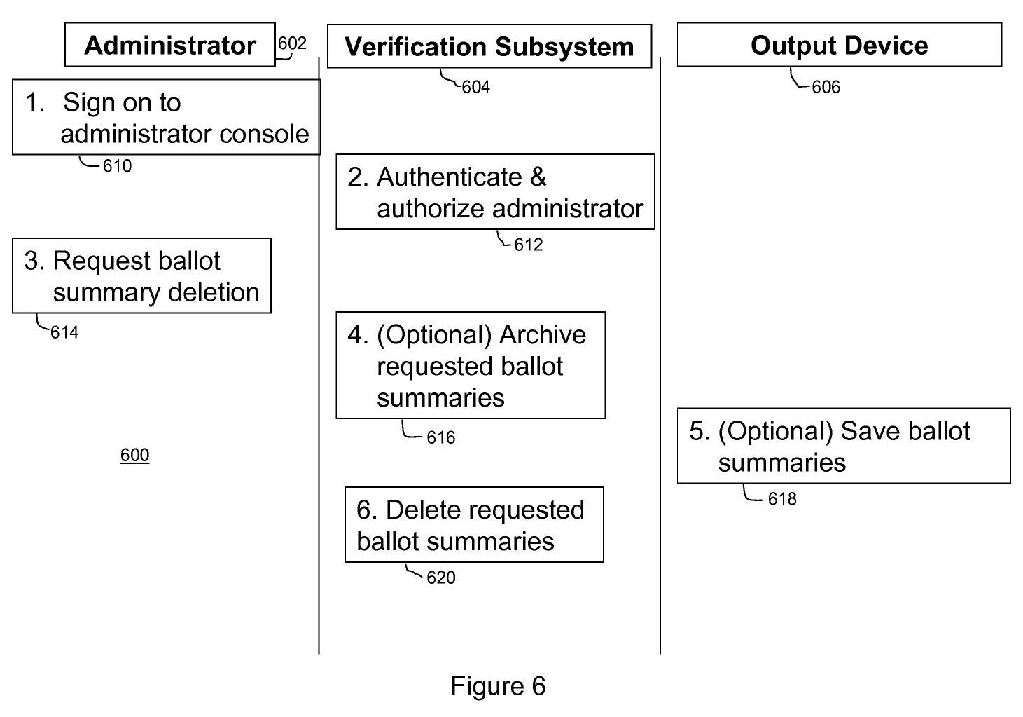

In some cases, ballot summaries are removed from the verification subsystem storage according to rules that govern the election. FIG. 6 shows a flow diagram depicting the basic protocol for deleting ballot summaries. Ballot summary system 600 includes administrator 602, verification subsystem 604 and output device 606 much like the system show in FIG. 5. In step 610, an administrator 602 attempts to sign on to the administrator console of the verification subsystem 604. This sign on procedure takes place on the device that stores the ballot summaries, which by definition is a TCP that only operates when it is in a known state. In step 612, the administrator's identity is authenticated and permissions are checked to make sure that the administrator is authorized to perform the ballot summary deletion operation by verification subsystem 604. Authentication can use any available method including, but not limited to, passwords, biometrics, smart cards, or combinations thereof Once identity has been established, the administrator 602 can only perform operations that have previously been granted. In addition, the sign on procedure for the verification subsystem can be integrated into other VDVS authentication and authorization procedures.

Once authenticated and authorized by verification subsystem 604, the administrator 602 requests in step 614 that ballot summaries be deleted. Depending on the rules that govern the election, the verification subsystem may allow, disallow, or require that the ballot summaries be archived before being removed from the verification subsystem storage. If archiving is in effect, then step 616 initiates the archiving operation, which copies the unchanged ballot summaries to an output device 606 that is part of the TCP in step 618. If archiving fails, step 620 is not executed. If archiving is requested and it succeeds, or if no archiving is requested, the verification subsystem removes the ballot summaries from its storage in step 620.

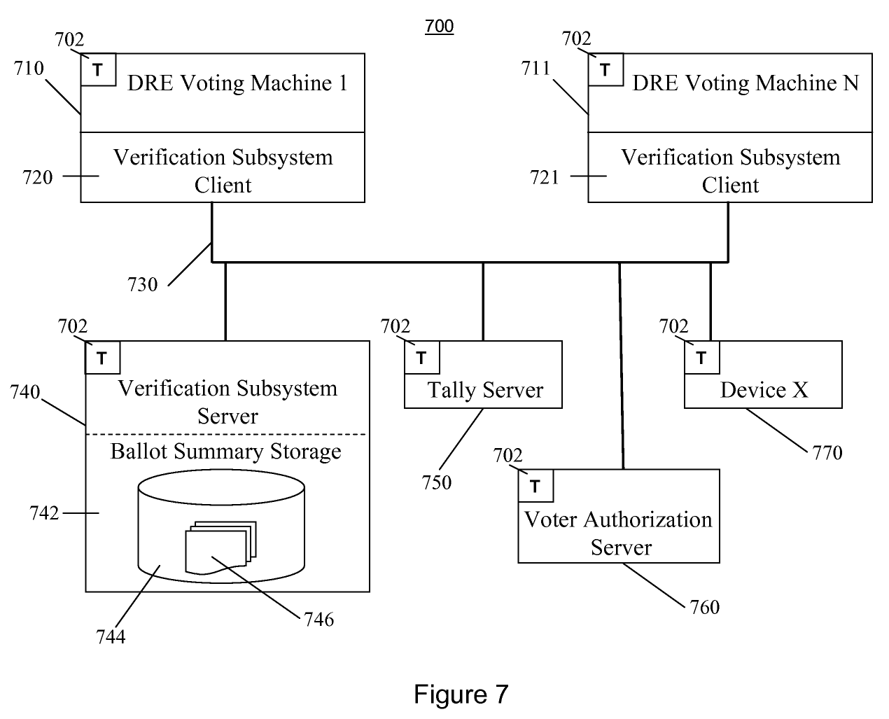

FIG. 7 shows a Verifiable DRE Voting System (VDVS) 700 that illustrates components of an exemplary voting system, though it can be appreciated that many other configurations are possible (two of which are described in FIGS. 1 and 2).

In FIG. 7, every device that participates in or interacts with the voting system must be executing in a trusted state as indicated by component 702 which is part of each component in voting system 700. Common component 702 depicts the root of trust in each device as shown. Typically, the root of trust is a hardware component embedded in a device that allows the device to report its identity and state when challenged. Once such a device is correctly configured, its reporting ability cannot be subverted by software means alone unless a successful cryptanalysis attack is made. In devices that implement the Trusted Computing Group standards, the Trusted Computing Module (TPM) is the main component of the root of trust.

The configuration in FIG. 7 includes one or more DRE voting machines 710, 711. Each DRE comprises all the typical DRE function required to display ballots and interact with voters, plus the client portion of the ballot verification subsystem 720, 721 used to initiate verification subsystem requests.

The DRE voting machines are connected to network 730, which allows the verification subsystem clients 720, 721 to communicate with the verification subsystem server 740. This server runs as a trusted computing platform and services verification subsystem requests from verification subsystem clients attached to the network. The verification subsystem server includes the ballot summary persistent storage 742, which may contain redundant storage devices 744 for improved reliability. The storage devices contain the actual ballot summaries 746 for each ballot that was cast.

FIG. 7 also shows a Tally Server 750 which is used to tally votes as ballots are cast, and a Voter Authorization Server 760 which determines whether a voter is authorized to vote at a specific time and place in an election. Device X 770 is a placeholder for one or more ancillary devices or servers that may be part of the VDVS. For example, these ancillary devices might be voter registration database server, printers, biometric readers, or bar code readers but are not limited to those listed. No matter what function the ancillary devices provide, they are all part of the trusted computing platform.

During elections, voters typically begin the voting process by receiving authorization to vote from the Voter Authorization Server 760. This process usually includes authenticating the identity of the voter and then checking that the voter can participate in the election according to the rules of the election. Once a voter is authorized, authorization information may be communicated to one or more DREs. This communication may use the network, 730, to provide a secure electronic channel between the server and DRE machines. Non-electronic protocols, however, can also be used to allow authorized voters to proceed to a DRE machine. For example, a simple protocol is to just deny physical access to DREs to unauthorized voters. In this case, the Voter Authorization Server does not need to be connected to network 730, though the server still needs to be a TCP running in a trusted state.

Once authorized, a voter uses a DRE machine to review the ballot and make selection. The ballot is typically displayed on a screen. When the voter has made his selections, the voter uses the DRE input controls to cast a ballot. The ballot verification subsystem 720, 721, and 740 produces a ballot summary that is shown to and checked by the voter. If the voter accepts that the ballot summary accurately reflects the vote, then the voter uses DRE input controls to commit the vote. This final action causes the vote to be tallied on the Tally Server 750 and causes the unchanged ballot summary to be saved on the storage media 744 that is controlled by the Verification Subsystem Server 740.

This process of ballot casting usually requires communication between different components of a VDVS over network 730. All components run as a TCP and each component attests that it is executing in trusted state before any communication proceeds. In addition, cryptographic techniques are used to assure the integrity and, where necessary, the confidentiality of data during transmission. Cryptographic techniques are also used to assure the integrity and confidentially of data when it stored.

It can be appreciated that the embodiment shown in FIG. 7 illustrates one configuration of a VDVS, but many variations are possible. For instance, the servers that are shown as separate entities in FIG. 7 could execute on the same physical server and, therefore, share the same root of trust.

It can be further be appreciated that several alternative embodiments can be envisioned as described below. In one embodiment, the ballot verification subsystem executes solely on the DRE vote input device and the saved ballot summaries reside securely and anonymously on permanent or removable persistent storage under control of the input device.

In another embodiment, the ballot verification subsystem executes on both a DRE input device and on another trusted device that makes up the voting system. The two devices communicate over a secure channel such that the ballot summaries that originate on the DRE input device can be stored securely and anonymously on permanent or removable persistent storage under control of the other trusted device. This auxiliary device can store ballot summaries from multiple DRE input devices.

In another embodiment, the ballot verification subsystem signs each ballot summary that it saves to cryptographically assure the ballot summary's authenticity and integrity. The keys used to sign and verify a ballot summary are protected by a TCP.

In another embodiment, the ballot verification subsystem encrypts each ballot summary that it saves to cryptographically assure the ballot summary's authenticity, integrity, and confidentiality. The keys used to sign, verify, encrypt, and decrypt a ballot summary are protected by a TCP.

In another embodiment, the ballot verification subsystem can sign a bundle of multiple ballot summaries one operation. This means that either all ballot summaries in the bundle are verified or none are.

In another embodiment, the ballot verification subsystem can encrypt a bundle of multiple ballot summaries one operation. This means that either all ballot summaries in the bundle are decrypted or none are.

In another embodiment, the ballot verification subsystem can seal ballot summaries such that they cannot be unsealed unless the TCP is in an expected configuration. The sealing process associates a TCP configuration with encrypted data such that the data cannot be decrypted unless the TCP is in the specified configuration.

In another embodiment, the ballot verification subsystem can write ballot summaries to a fully encrypted storage device. Even if the encrypted storage device is moved to another machine, no information can be read unless the proper key is used or unless a cryptanalysis attack is successful.

In another embodiment, the ballot verification subsystem preserves voter anonymity by disabling or removing any file system meta-data or log records that could be used to associate a voter with a saved ballot summary. The ballot verification subsystem can also clear any hardware caches or buffers that could be used to reconstruct how a voter voted.

In another embodiment, the ballot verification subsystem stores ballot summaries on recoverable storage devices that use RAID or some other data redundancy protocol.

In another embodiment, the ballot verification subsystem presents the ballot summary file to the voter before the ballot is cast and saves that file unchanged (except for possible cryptographic protections) when the voter casts the ballot. The file can be in any format including, but not limited to, text, PDF, JPEG, GIF, or TIFF.

In another embodiment, the ballot verification subsystem outputs the saved ballot summaries when authenticated users with the proper authorization initiate an output request. An output request can be used to copy, move, or view the ballot summaries, but never to change them. The ballot summaries can be outputted to any target including, but not limited to, display devices, storage devices, printers, and unencrypted files.

In another embodiment, the ballot verification subsystem deletes the saved ballot summaries when authenticated users with the proper authorization initiate a deletion request.

In another embodiment, the application source code for DRE input devices, the ballot verification subsystem, and, optionally, other parts of the voting system, including BIOS, boot loader, operating system, and device driver code, is made publicly available to increase confidence in the correctness of the system.

In another embodiment, the application source code for DRE input devices, the ballot verification subsystem, and, optionally, other parts of the voting system, including BIOS, boot loader, operating system, and device driver code, is inspected, validated, attested to, and kept in escrow by a trusted third party to increase confidence in the correctness of the system. This trusted third party would have fiduciary responsibility to election officials, government regulatory agencies, or the public in general, and can be legally sanctioned to disclose proprietary source under certain conditions.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

We claim:

1. A method for a paper-free, verifiable, electronic voting system, said method comprising the steps of:
a) submitting votes by a voter using a direct-recording electronic voting machine;
b) requesting a ballot summary from said direct-recording electronic voting machine;
c) creating a ballot summary in a verification subsystem;
d) displaying said ballot summary by said voting machine;
e) casting a ballot by said voter;
f) tallying votes by said electronic voting system;
g) requesting said ballot summary be saved by said voting machine;
h) saving said ballot summary securely by said verification subsystem; and
i) displaying a cast ballot message on said voting machine.

2. The method of claim 1 whereby said electronic voting system executes as part of a trusted computing platform.

3. The method of claim 2 whereby said trusted computing platform allows only known, verified code to execute as part of said electronic voting system.

4. The method of claim 2 whereby all components of said trusted computing platform and of said electronic voting system have been independently certified as secure and correct in accordance with applicable laws.

5. The method of claim 2 further comprising the steps of:
a) performing a mutual attestation protocol between a verification client and a verification server,
b) possibly over a network, said verification client and said verification server being parts of said verification subsystem.

6. The method of claim 5 further comprising the steps of:
a) receiving at a verification server a request over said network from a verification client to save a ballot summary;
b) sending a response from said verification server to said verification client after saving; said ballot summary securely by said verification subsystem;
c) receiving said response by said verification client; and
d) displaying a cast ballot message on said voting machine.

7. The method of claim 2 further comprising the steps of:
a) signing on to an administrator console by an administrator;
b) authenticating and authorizing said administrator on a verification subsystem;
c) requesting deletion of said ballot summary by said administrator;
d) archiving said ballot summaries by said verification subsystem;
e) saving said ballot summaries by an output device; and
f) deleting said ballot summaries by said verification subsystem.

8. The method of claim 2 further comprising the steps of:
a) signing on to an administrator console by an administrator;
b) authenticating and authorizing said administrator on a verification subsystem;
c) requesting a ballot summary output by said administrator;
d) decrypting and checking integrity of requested said ballot summaries; and
e) outputting verified ballot summaries in clear text.

9. The method of claim 2 further comprising the step of digitally signing each individual ballot summary to cryptographically assure authenticity and integrity.

10. The method of claim 2 further comprising the step of encrypting each individual ballot summary to cryptographically assure authenticity, integrity, and confidentiality.

11. The method of claim 2 further comprising the step of digitally signing multiple ballot summaries to cryptographically assure authenticity and integrity of said ballot summaries as a unit.

12. The method of claim 2 further comprising the step of encrypting multiple ballot summaries to cryptographically assure authenticity, integrity, and confidentiality of said ballot summaries as a unit.

13. The method of claim 2 further comprising the step of sealing said ballot summaries such that said ballot summaries cannot be read unless the trusted computing platform is in an expected configuration.

14. The method of claim 2 further comprising the step of writing said ballot summaries to a fully encrypted storage device.

15. The method of claim 2 further comprising the step of making source code of said electronic voting system publicly available to increase confidence in correctness of said electronic voting system.

16. The method of claim 2 further comprising the step of allowing a trusted third party to inspect, validate, attest to, and keep in escrow source code of said electronic voting system to increase confidence in correctness of said electronic voting system.

17. The method of claim 2 further comprising the step of protecting voter anonymity by obfuscating an order in which said ballot summaries are created and saved.

18. The method of claim 17 further comprising the step of saving said ballot summaries to random locations in said ballot summary repository.

19. The method of claim 17 further comprising the step of removing, disabling, or overwriting timestamps associated with said saved ballot summaries.
